(19) United States
(12) Patent Application Publication
(10) Pub. No.: US 2018/0326509 A1
(43) Pub. Date: Nov. 15, 2018

(54) MACHINING TOOL

(71) Applicant: ALBERT KNEBEL HOLDING GMBH, BALINGEN (DE)

(72) Inventors: PHILIPP WOERMANN, RIETBERG (DE); GUENTER HERMBUSCHE, HOEVELHOF/RIEGE (DE)

(73) Assignee: ALBERT KNEBEL HOLDING GMBH, BALINGEN (DE)

(21) Appl. No.: 15/774,158

(22) PCT Filed: Nov. 8, 2016
(86) PCT No.: PCT/EP2016/076955

§ 371 Date: May 7, 2018

(30) Foreign Application Priority Data
Nov. 10, 2015 (DE) 20 2015 106 056.4

(51) Int. Cl. B23C 5/10

(52) U.S. Cl. CPC B23C 5/10; B23C 2210/088; B23C 2226/27; B23C 2210/0492

(57) ABSTRACT

A machining tool for machining fiber-reinforced materials, which comprises a plurality of flutes which separate lands from each other in the circumferential direction, wherein at least one land includes a plurality of cutting edges on its circumferential side, the cutting edges extending at a helix angle (a1-an, b1-bn, c1-cn, d1-dn) having an absolute value >25° with respect to the longitudinal axis of the machining tool, wherein at least two cutting edges on the at least one land have different helix angles (a1-an, b1-bn, c1-cn, d1-dn).

The invention relates to a machining tool for machining fiber-reinforced materials, which comprises a plurality of flutes which separate lands from each other in the circumferential direction, wherein at least one land includes a plurality of cutting edges on its circumferential side, the cutting edges extending at a helix angle having an absolute value >25° with respect to the longitudinal axis of the machining tool.

Such a machining tool is described in WO2014/056582 A1, for example. The machining tool described therein comprises a plurality of flutes which separate webs from each other in the circumferential direction, the webs having been placed around a cylinder core segment. In this case, at least one of the webs is designed as a premachining web and at least one other of the webs is designed as a postmachining web, each of which includes a circumferential working area extending along, or with a twist and in the form of a helical segment about, the tool axis of the machining tool. Provided in the working area of each postmachining web is a number of sharp cutting edges extending in parallel to, or with a twist and in the form of a helical segment about, the tool axis. The number of sharp cutting edges on at least one postmachining web includes a plurality of cutting edges, each of which is provided on a circumferential casing groove, wherein the casing grooves are formed in a cylinder surface segment-shaped lateral surface of the working area, in parallel to each other and at a pitch relative to the flute leading at least one postmachining web.

In the machining of fiber-reinforced materials, such as CFRP or glass fiber-reinforced plastics, cut quality and low-noise operation have conflicting goals. Measures which improve the cut quality have the side effect of a poorer low-noise operation. If work is carried out using a counterdirectional helix angle in order to improve the cut quality, and if the helix angle has an absolute value greater than 30°, the cut quality and the edge quality improve. This results in a change in the direction of force. Due to the change in direction of the forces, an excitation to oscillation of the workpiece takes place. The excitation is facilitated by a constant excitation frequency and by constant directions of the excitation forces.

The problem addressed by the present invention is therefore that of providing a machining tool, with the aid of which both cut quality and low-noise operation can be improved.

This problem is solved, according to the invention, by a machining tool for machining fiber-reinforced materials, which comprises a plurality of flutes which separate lands from each other in the circumferential direction, wherein at least one land includes a plurality of cutting edges on its circumferential side, the cutting edges extending at a helix angle having an absolute value >25°, preferably >30°, with respect to the longitudinal axis of the machining tool, wherein, on the at least one land, at least two cutting edges have different helix angles. Given that at least two cutting edges have different helix angles, there are different directions for excitation forces. The excitation to oscillation of the workpiece is therefore reduced. A better low-noise operation therefore results. The provision of helix angles >25° improves the cut quality. The helix angle, in this case, is the angle with respect to the longitudinal axis of the machining tool for implementing the cutting lip of a cutting edge.

It is particularly preferred when no cutting edges oriented in parallel to each other are provided on a land.

The flutes of the machining tool act as chip guides. As a result, the chips can be carried away particularly well.

It is particularly preferred when all cutting edges of a land have different helix angles. This yields a scattering in the direction of the force vectors at the individual cutting edges, and therefore the low-noise operation can be further improved.

According to one embodiment of the invention, it can be provided that the cutting edges of a first land have a positive helix angle and the cutting edges of a land following in the circumferential direction have a negative helix angle, or vice versa. Due to this measure, the cut quality, in particular of narrow surfaces, i.e., very thin plate materials or thin freeform parts, can be improved.

Further advantages result when, on one land, a first group of cutting edges is provided, each cutting edge having a helix angle, the absolute value of which is less than a first predefined helix angle, and a second group of cutting edges is provided, each of which has a helix angle, the absolute value of which is greater than a second predefined helix angle, wherein the second predefined helix angle has an absolute value which is greater than or equal to the first predefined helix angle. Due to this scattering of the helix angles, the excitation to oscillation of a component can be reduced, thereby resulting in an improved low-noise operation.

According to one refinement, it can be provided that all cutting edges in one group have different helix angles. The scattering in the direction of the force vectors is increased once again as a result.

Cutting edges of the first and the second groups can be situated in alternation in the longitudinal direction of the machining tool. Due to this measure, it is ensured that the directions of the force vectors of adjacent cutting edges deviate substantially from each other.

Further advantages result when the difference of the first and the second predefined helix angles is greater than the difference of any two helix angles within one group. The helix angles of cutting edges in one group are therefore relatively close to each other, while the helix angles of cutting edges in different groups are separated by a relatively great distance.

Each land can comprise, exclusively, cutting edges having a positive helix angle or, exclusively, cutting edges having a negative cutting angle.

According to yet another embodiment of the invention, it can also be provided that cutting edges having positive and negative helix angles are situated on one land. In particular, cutting edges having a positive helix angle and a negative helix angle can alternate on one land. It is particularly preferred when at least one cutting edge having a positive helix angle and a cutting edge having a negative helix angle intersect.

A chip space and a flank can be assigned to each cutting edge. A reliable removal of chips is ensured as a result.

The cutting lip of at least one cutting edge can be formed with a circularly ground land. This results in an improvement on the tool life travel path.

Further advantages result when one or multiple cutting edges is/are provided between two lands spaced apart by a flute, the cutting edges having an angle with respect to the longitudinal axis of the machining tool in the range −15° to +15°, preferably in the range −10° to +10°. These cutting edges have a positive effect on the low-noise operation of the tool. At the same time, the cut quality marginally worsens. These additional cutting edges increase the number of teeth of the tool, whereby higher feed rates can be achieved. Yet another positive effect is an improvement on the chip conveyance in the direction of the removal by suction.

Further features and advantages of the invention result from the detailed description of exemplary embodiments of the invention that follows, with reference to the figures in the drawing which shows the details that are essential to the present invention. Further features and advantages of the present invention also result from the claims. The features described therein are not intended to be interpreted literally, and are presented in such a manner that the special features of the present invention may be presented clearly. The various features can be implemented individually, or these can be combined in any possible manner in different variants of the invention.

Exemplary embodiments of the invention are represented in the schematic drawing and are described in greater detail in the description which follows.

In the drawing:

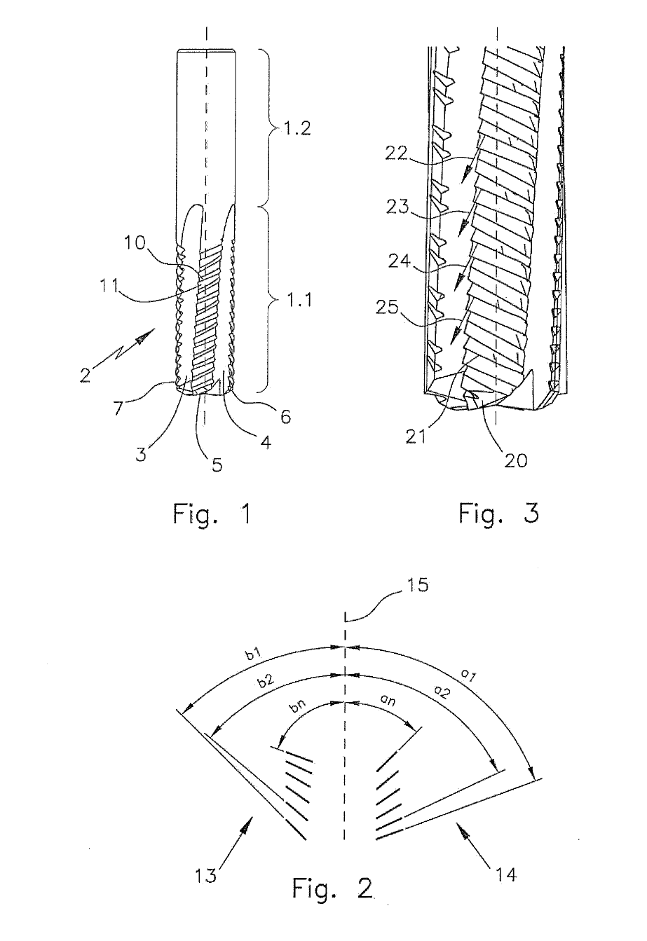

FIG. 1 shows a perspective representation of the cutting section of a machining tool;

FIG. 2 shows one implementation of cutting lips of cutting edges;

FIG. 3 shows a representation of the cutting section of a machining tool for indicating different force vectors;

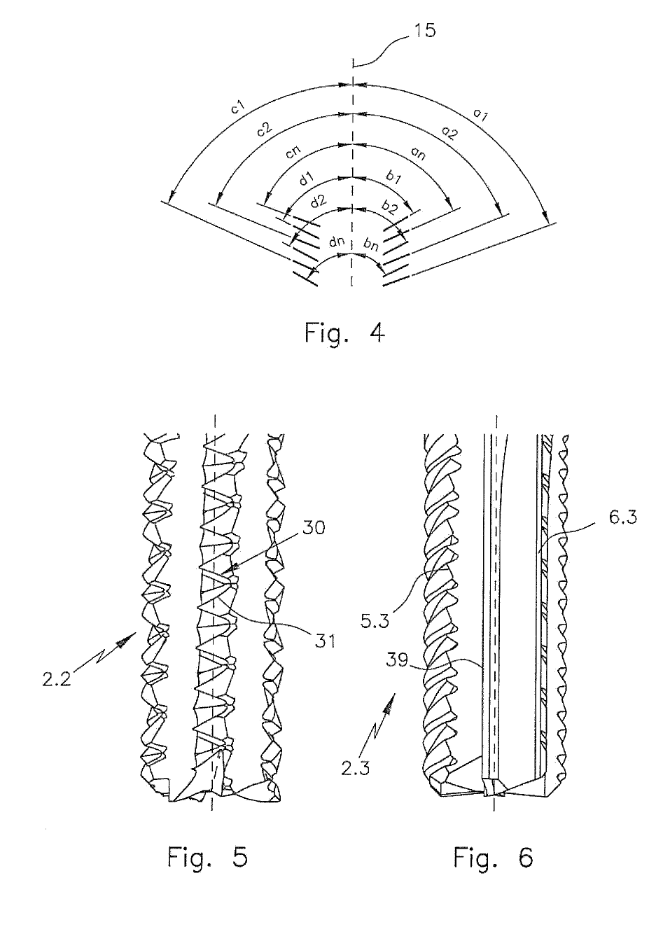

FIG. 4 shows yet another representation of implementations of cutting lips for indicating different groups of cutting lips having different helix angles;

FIG. 5 shows the cutting section of a machining tool comprising cutting edges having a positive helix angle and a negative helix angle;

FIG. 6 shows a perspective representation of a cutting section of a machining tool comprising a cutting edge between the lands of the machining tool; and

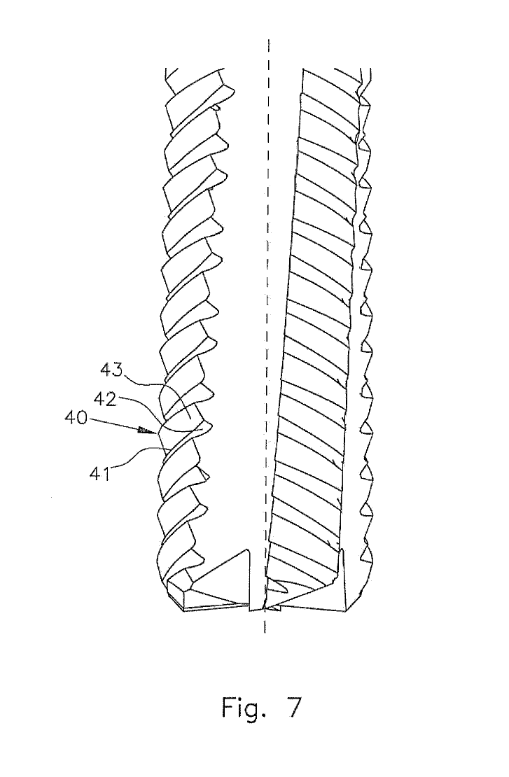

FIG. 7 shows cutting edges including assigned cutting lips, chip space, and flank.

FIG. 1 shows the cutting section 1.1 of a machining tool 2. Adjoining the cutting section 1.1 at the top is yet another section 1.2, with the aid of which the machining tool 2 can be clamped.

The machining tool 2 is designed substantially cylindrically. The machining tool comprises flutes 3, 4 which separate lands 5, 6, 7 from each other. By way of the land 5, it is shown that the lands 5 to 7 comprise cutting edges 10 on the circumference. The cutting edges 10 are spaced apart from each other by grooves 11.

FIG. 2 shows one implementation of cutting lips 13, 14 of cutting edges, such as the cutting edge 10. The cutting lips 14 have a positive helix angle a1, a2, an. This means, the angles a1, a2, an with respect to the longitudinal axis 15 of the machining tool 2 are positive. All cutting edges, including their assigned cutting lips 14, have different helix angles a1, a2, an. This means, a1≠a2≠an.

The cutting edges including the cutting lips 13 therefore have a negative helix angle b1, b2, bn. In this case, it also applies that b1≠b2≠bn. This means, there are no cutting edges whose cutting lips extend in parallel. The cutting lips 13 having the negative helix angle b1, b2, bn can be situated on a first land and the cutting edges including assigned cutting lips 14 can be situated on an adjacent land. Therefore, lands 5 to 7 spaced apart by a flute 3, 4 are provided with cutting edges having helix angles having different signs.

FIG. 3 shows a land 20 which comprises cutting edges 21 having negative helix angles b1, b2, bn. This yields different directions of the force vectors 22, 23, 24, 25 from cutting edge to cutting edge. The low-noise operation is improved as a result.

Yet another embodiment is shown in FIG. 4, wherein implementations of cutting lips of cutting edges are also represented here. A first land comprises cutting edges having a negative helix angle c1 to cn and d1 to dn. The following land has positive helix angles a1 to an and b1 to bn. Cutting edges from two groups are situated in alternation on each land. All helix angles are different (a1≠a2≠an; b1≠b2≠bn; c1≠c2≠cn; d1≠d2≠dn) within each group a, b, c, d. The two groups per land have a higher difference between the helix angles than the difference of the helix angles within one group. This constellation yields a scattering in the direction of the force vectors.

In particular, it is provided in this case that the helix angles c1, c2, cn have greater absolute values than a predefined first helix angle and the helix angles d1, d2, dn have lower absolute values than a predefined second helix angle. The predefined helix angles can be the same or different. When different predefined helix angles are provided, the predefined helix angle which is less than c1, c2, cn is greater than the predefined helix angle which is greater than the helix angles d1, d2, dn.

The same applies for the helix angles a1, a2, an and b1, b2, bn.

FIG. 5 shows yet another embodiment of a machining tool 2.2, in which cutting edges 30 having a positive helix angle and cutting edges 31 having a negative helix angle are situated on one land.

All helix angles have an absolute value greater than 30°. Cutting edges 30, 31 having a positive helix angle and a negative helix angle can intersect.

In the embodiment of a machining tool 2.3 according to FIG. 6, yet another cutting edge 39 is situated between the land 5.3 and the land 6.3, which has an angle with respect to the longitudinal axis of the machining tool 2.3 in the range between −10° and +10°. In the exemplary embodiment shown, the cutting edge has an angle, in particular, of 0° with respect to the longitudinal axis of the machining tool 2.3.

As shown in FIG. 7, assigned to each cutting edge 40 is a cutting lip 41, a chip space 42, and a flank 43.

1. A machining tool (2, 2.2, 2.3) for machining fiber-reinforced materials, which comprises a plurality of flutes (3, 4) which separate lands (5, 6, 7, 20, 5.3, 6.3) from each other in the circumferential direction, wherein at least one land (5, 6, 7, 20, 5.3, 6.3) includes a plurality of cutting edges (10, 21, 30, 31, 39) on its circumferential side, the cutting edges extending at a helix angle (a1-an, b1-bn, c1-cn, d1-dn) having an absolute value >25° with respect to the longitudinal axis (15) of the machining tool (2, 2.2, 2.3), wherein at least two cutting edges (10, 21, 30, 31, 39) on the at least one land (5, 6, 7, 20, 5.3, 6.3) have different helix angles (a1-an, b1-bn, c1-cn, d1-dn).

2. The machining tool as claimed in claim 1, wherein all cutting edges (10, 21, 30, 31, 39) of a land (5, 6, 7, 20, 5.3, 6.3) have different helix angles (a1-an, b1-bn, c1-cn, d1-dn).

3. The machining tool as claimed in claim 1, wherein the cutting edges (10, 21, 30, 31, 39) of a first land (5, 6, 7, 20, 5.3, 6.3) have a positive helix angle (a1-an) and the cutting edges of a land following in the circumferential direction have a negative helix angle (b1-bn), or vice versa.

4. The machining tool as claimed in claim 1, wherein, on one land (5, 6, 7, 20, 5.3, 6.3) a first group (b, d) of cutting edges is provided, each of which has a helix angle (b1-bn, d1-dn) having a smaller absolute value than a first predefined helix angle, and a second group (a, c) of cutting edges is provided, each of which has a helix angle (a1-an, c1-cn) having a greater absolute value than a second predefined helix angle, wherein the absolute value of the second predefined helix angle is greater than or equal to the first predefined helix angle.

5. The machining tool as claimed in claim 4, wherein all cutting edges (13, 14) of a group (a, b, c, d) have different helix angles (a1-an, b1-bn, c1-cn, d1-dn).

6. The machining tool as claimed in one of claim 4, wherein cutting edges of the first and the second groups (a, b, c, d) are situated in alternation in the longitudinal direction of the machining tool.

7. The machining tool as claimed in claim 4, wherein the difference of the first and the second predefined helix angles is greater than the difference of any two helix angles (a1-an, b1-bn, c1-cn, d1-dn) within one group (a, b, c, d).

8. The machining tool as claimed in claim 1, wherein cutting edges (30, 31) having positive and negative helix angles are situated on one land.

9. The machining tool as claimed in claim 8, wherein at least one cutting edge (30, 31) having a positive helix angle and a cutting edge having a negative helix angle intersect.

10. The machining tool as claimed in claim 1, wherein assigned to each cutting edge (40) is a chip space (42) and a flank (43).

11. The machining tool as claimed in claim 1, wherein the cutting lip of at least one cutting edge is formed with a circularly ground land.

12. The machining tool as claimed in claim 1, wherein one or multiple cutting edges (39) is/are provided between two lands (5.3, 6.3) spaced apart by a flute, the cutting edges having an angle with respect to the longitudinal axis of the machining tool in the range −15° to +15°, preferably in the range −10° to +10°.
